(19) United States
(12) Patent Application Publication
(10) Pub. No.: US 2026/0173202 A1
(43) Pub. Date: Jun. 18, 2026

(54) NETWORK NODE, FIRST USER EQUIPMENT, AND METHODS THEREIN, IN A WIRELESS COMMUNICATIONS NETWORK

(71) Applicant: Telefonaktiebolaget LM Ericsson (publ), Stockholm (SE)

(72) Inventor: Erik STARE, Sollentuna (SE)

(21) Appl. No.: 19/125,813

(22) PCT Filed: Oct. 30, 2023
(86) PCT No.: PCT/EP2023/080188

§ 371 Date: Apr. 30, 2025

Related U.S. Application Data
(60) Provisional application No. 63/422,122, filed on Nov. 3, 2022.

(51) Int. Cl. H04W 76/28; H04W 76/40

(52) U.S. Cl. CPC H04W 76/28; H04W 76/40

(57) ABSTRACT

A method performed by a first UE for handling a multicast session between a network node and a group of UEs comprising at least the first UE in a wireless communications network is provided. The first UE operates under a second Discontinuous Reception (DRX) configuration. The first UE detects that the multicast session is activated by receiving a group paging message to the group of UEs indicating that the multicast session is activated, or by receiving session data of the multicast session. In response to detecting that the multicast session is activated, the first UE switches from the second DRX configuration to a first DRX configuration. The first DRX configuration indicates that the first UE shall monitor all session data transmitted in the multicast session. The second DRX configuration indicates that the first UE shall monitor a subset of all the session data transmitted in the multicast session.

### TECHNICAL FIELD

Embodiments herein relate to a User Equipment (UE), a network node, and methods therein. In some aspects, they relate to handling a multicast session between a network node and a group of UEs in a wireless communications network.

### BACKGROUND

In a typical wireless communication network, wireless devices, also known as wireless communication devices, mobile stations, stations (STA) and/or User Equipment, communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a 5G network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques may significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO.

When a 3GPP Release 17 (Rel-17) Multicast Broadcast System (MBS) session, also referred to as multicast session, is activated, deactivated, or released, the Core Network (CN) informs each Next Generation RAN (NG-RAN) node, where a multicast session is provided, about a corresponding session status change. Each NG-RAN node may then perform group paging within its own cells.

In Rel-17, the group paging message includes a Temporary Mobile Group Identity (TMGI) of the MBS session and no other information. A given group paging message may include one or more such TMGIs, depending on which MBS session(s), group paging is needed.

Since the UEs that need to be group paged for a given TMGI/MBS session may be configured to monitor different Paging Occasions (POs), the same TMGI may be transmitted in several and potentially all POs. This allows each MBS UE to be group paged while still monitoring its legacy POs. The UE identity, used for legacy unicast paging, may be contained in the same paging message as used for group paging, i.e. each PO may contain an arbitrary mix of UE identities, used for individual UE paging, and/or TMGIs, used for group paging.

In Rel-17, a full-length TMGI is transmitted in each PO used for group paging.

### SUMMARY

A problem with handling multicast sessions has been identified by the inventors and will first be discussed. For being able to receive relevant data in a multicast session, UEs may need to monitor all session data all the time, and If the multicast session and UEs are inactive, a network node needs to transmit group paging indicative of an activation of a multicast session iteratively until it can be ensured that all the UEs have received the group paging and are ready to receive session data. This procedure is resource intensive, in particular with respect to power usage.

An object of embodiments herein is to improve performance of handling multicast sessions.

According to a first aspect, a method performed by a first UE for handling a multicast session between a network node and a group of UEs comprising at least the first UE, in a wireless communications network is provided. The first UE operates under a second Discontinuous Reception (DRX) configuration. The second DRX configuration indicates that the first UE shall monitor a subset of all the session data transmitted in the multicast session. The first UE detects that the multicast session is activated by any one of: receiving a group paging message to the group of UEs indicating that the multicast session is activated, or by receiving session data of the multicast session. In response to detecting that the multicast session is activated, the first UE switches from the second DRX configuration to a first DRX configuration. The first DRX configuration indicates that the first UE shall monitor all session data transmitted in the multicast session.

According to a second aspect, a method performed by a network node for handling a multicast session between the network node and a group of UEs comprising at least a first UE, in a wireless communications network is provided. The first UE operates under a second DRX configuration. The network node transmits to the group of UEs, a group paging message indicating that the multicast session is activated. The network node transmits to the group of UEs, session data associated with the multicast session. The session data is transmitted to be at least partly receivable by the first UE operating under the second DRX configuration, and thereby further indicating to the first UE that the multicast session is activated.

According to a third aspect, a first UE configured to handle a multicast session between a network node and a group of UEs comprising at least the first UE, in a wireless communications network is provided. The first UE is configured to operate under a second DRX configuration. The first UE is configured to:
detect that the multicast session is activated by any one of: receive, a group paging message to the group of UEs indicating that the multicast session is activated, or by receive, session data of the multicast session,
in response to detecting that the multicast session is activated, switch, from the second DRX configuration to a first DRX configuration, wherein the first DRX configuration is adapted to indicate that the first UE shall monitor all session data transmitted in the multicast session, and wherein the second DRX configuration is adapted to indicate that the first UE shall monitor a subset of all the session data transmitted in the multicast session.

According to a fourth aspect, a network node configured to handle a multicast session between the network node and a group of UEs comprising at least a first UE in a wireless communications network, is provided. The first UE is adapted to operate under a second DRX configuration. The network node is configured to:
transmit to the group of UEs, a group paging message indicating that the multicast session is activated, and
transmit session data associated with the multicast session, the session data being transmitted to be at least partly receivable by the first UE operating under the second DRX configuration, and thereby further indicating to the first UE that the multicast session is activated.

Since the first UE detects that a multicast session is activated either by group paging or by monitoring the session for session data, as sent from the network node, while the first UE is using the second DRX configuration, the first UE is enabled to detect session activations without having to monitor every session data. Furthermore, no repetition of the group paging message is needed as the first UE may also detect the transmitted session data in the second DRX configuration if the group paging message would not be detected. Thereby, a more efficient handling of multicast session activation is achieved while also improving power efficiency of the first UE and network node. This is since the network node will not be required to send repeating paging signals, and the UE may reduce power by operating in the second DRX configuration which reduces power compared to operating normally without DRX and/or compared to operating under the first DRX configuration.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting embodiments of a method performed by a first UE.

FIG. 3 is a flowchart depicting embodiments of a method performed by a network node.

FIG. 4 is a diagram depicting an example scenario of embodiments.

FIG. 5 is a sequence diagram depicting an example scenario of embodiments.

FIG. 6 a and b are schematic block diagrams illustrating embodiments of a first UE.

FIG. 7 a and b are schematic block diagrams illustrating embodiments of a network node.

FIGS. 8-10 schematically illustrates a communication system in accordance with some embodiments.

### DETAILED DESCRIPTION

As a part of developing embodiments herein the inventors have identified problems with multicast sessions as introduced in the summary, which will be further discussed in more detail below. In embodiments herein the term multicast session may refer to an MBS session or an MBS multicast session, and the terms may be used interchangeably to define the same type of multicast session. If not explicitly stated otherwise, a session as used herein may be a multicast session.

In 3GPP Rel-17 , for multicast sessions such as a multicast MBS session, there is no support for multicast reception when a Rel-17 UE operates in an inactive mobility state, e.g., Radio Resource Control (RRC) inactive, or also referred to as RRC INACTIVE. Consequently, in Rel-17, there is no need to notify the Rel-17 UE about corresponding session status via group paging. Instead, group paging is simply used to bring UEs back to a connected mobility states, e.g., RRC CONNECTED. Typically, this is achieved as a result of an MBS session activation, so the UEs can receive the MBS session in RRC CONNECTED, but in principle there may be other reasons for the RAN to group page RRC INACTIVE UEs.

Release 18(Rel-18 ) will however support multicast reception in RRC INACTIVE. In one scenario, a Rel-18 UE is released from RRC CONNECTED to RRC INACTIVE when the session is deactivated. The Rel-18 UE may accordingly wait in RRC INACTIVE for the session to be activated, to start receiving multicast data. A Rel-18 UE as used herein may mean a UE with capabilities conforming to the Release-18 3GPP specifications.

If no explicit session activation notification is provided to the Rel-18 UE in RRC INACTIVE, the Rel-18 UE will have to monitor the session all the time in RRC INACTIVE, as if the session is activated all the time. In this way, the Rel-18 UE can receive multicast in RRC INACTIVE, but such an approach will unnecessarily consume power for the UE during time periods when the session is deactivated.

If explicit session activation notification is provided for Rel-18 UEs in RRC INACTIVE, which are expected to stay in RRC INACTIVE and receive multicast when the session is activated, it is essential that the Rel-18 UE receive the notification or at least somehow detects that the session is activated.

If notification of session activation is provided via a single group paging, it may happen that the Rel-18 UE misses the group paging for various reasons, e.g., due to poor radio conditions. For legacy unicast and for Rel-17 multicast, a paged UE in RRC INACTIVE is expected to resume to RRC CONNECTED, which means that network node will get feedback as to whether the UE received the paging, e.g., as part of an RRC resumption operation. For UEs that miss the paging the network node can send repeated paging messages until all UEs have resumed, or any remaining missing UEs may be deemed to be outside of coverage.

However, if a Rel-18 UE is expected to stay in RRC INACTIVE, a missed paging will not be detected by either the Rel-18 UE or the network node, so the Rel-18 UE will continue waiting for a session activation notification message that may never come. This means that the Rel-18 UE may risk losing all data sent in a multicast session, e.g., MBS session.

One solution for a network node such as a gNB is to repeat group paging until it considers the residual probability, that the Rel-18 UE has not received the notification, small enough. This solution requires a trade-off between overhead, due to repeated group paging, and sufficiently low residual probability that the Rel-18 UE has missed the notification.

Embodiments herein addresses and overcomes at least part of the abovementioned problems as will be further discussed.

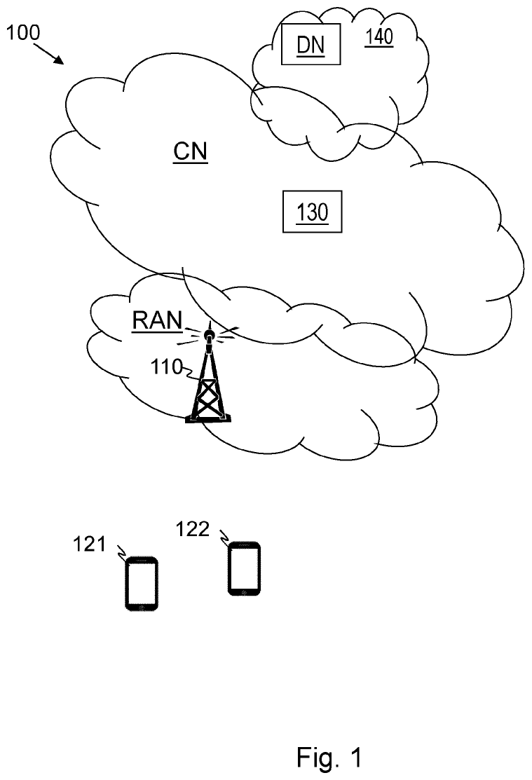

FIG. 1 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, (LTE), LTE-Advanced, Wideband Code Division Multiple Access (WCDMA), Global System for Mobile communications/enhanced Data rate for GSM evolution (GSM/EDGE), or ultra mobile broadband (UMB), just to mention a few possible implementations.

Network nodes such as a network node 110 operates in the wireless communications network 100. The network node 110 may provide a number of cells referred, and may use these cells for communicating with any one or more suitable UEs operating in these cells. The network node 110 may be a transmission and reception point e.g. a radio access network node such as a base station, e.g. a radio base station such as a NodeB, an evolved Node B (eNB, eNodeB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE within any cell served by the network node 110, e.g. depending on the radio access technology and terminology used. In particular, the first network node 110 may be able to send group paging messages to UEs comprising multicast session identifiers, e.g., TMGIs.

User Equipment operate in the wireless communications network 100, such as a first UE 121. In the wireless communications network 100, a second UE 122 may also operate. The first UE 121 and the second UE 122 may respectively provide radio coverage by means of a number of antenna beams, also referred to as beams herein.

The first UE 121 and the second UE 122 may respectively e.g. be an NR device, a mobile station, a wireless terminal, an NB-IoT device, an eMTC device, an NR RedCap device, a CAT-M device, a Wi-Fi device, an LTE device and a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

The first UE 121 may be a Rel-18 capable UE, i.e. a Rel-18 UE. The second UE 122 may be a Rel-17 UE or a Rel-18 UE. Any one or both of the first UE 121 and the second UE 122 may be part of one or more groups of UEs (not shown), which respective groups of UEs may be part of the same session, e.g., multicast MBS session, between the respective group and the network node 110.

The first UE 121 may be capable of operating using any suitable mobility state, e.g., RRC Inactive, while receiving multicast session data. The first UE 121 may be capable of operating using different DRX configurations, e.g., switchable by the first UE 121.

CN nodes such as a CN node 130 operates in the wireless communications network 100. the CN node 130 may be configured to inform, e.g., signal, each network node such as the network node 110 where a session, e.g., multicast MBS session, is provided, e.g., between which one or more UEs and which network node, and/or about a session status change of the session. In this way, each network node such as the network node 110, may be triggered to perform group paging towards a group of UEs associated with the session, e.g., the first UE 121 and/or the second UE 122.

Methods herein may in one aspect be performed by the network node 110, and in another aspect by the first UE 121. As an alternative, a Distributed Node (DN) and functionality, e.g. comprised in a cloud 140 as shown in FIG. 1, may be used for performing or partly performing the methods and embodiments herein.

In embodiments herein a UE, e.g., the first UE 121, may be configured with two alternative DRX configurations. These are to be used to receive an MBS session and comprises a first DRX configuration, also referred to as DRX1, and a second DRX configuration, also referred to as DRX2. In some embodiments herein, the first DRX configuration may also be referred to as normal DRX or a standard DRX. In some embodiments herein, the second DRX configuration may be referred to as a sparse DRX configuration. Each DRX configuration may be a low-power configuration for a UE, e.g., the first UE 121. For example, the DRX configuration may determine how long to sleep and/or how long to not listen to, or not to monitor, certain radio transmissions, e.g., multicast transmissions. A time period for how long to sleep, how long to be configured in a low-power mode, and/or how long to not listen to or monitor to at least some type of radio, e.g., multicast session data, may be defined by a respective cycle time. In this respect, the second DRX configuration may have a longer cycle time than the first DRX configuration, i.e. the second DRX configuration monitors less multicast transmission than the first DRX configuration. A DRX may additionally or alternatively be defined as any suitable manner of configuring a UE, e.g., the first UE 121, to monitor a subset of all logically possible Monitoring Occasions (MOs), e.g., of one or more recurring radio frames. In this context, the first DRX configuration comprises monitoring more subsets than the second DRX configuration. A longer cycle time in this context may mean less monitored MOs for the second DRX configuration than for the first DRX configuration.

In some embodiments herein, the UE, e.g., the first UE 121, may selectively use the first DRX configuration, or the second DRX configuration. When using the second DRX configuration, the UE, e.g., the first UE 121, may consider a session state of a multicast session, e.g., an MBS session, to be deactivated. In other words, the second DRX configuration may be used for non-active multicast sessions. In these embodiments, the UE may monitor paging messages but also at least a part of the multicast session according to the second DRX configuration, DRX2. In other words, the UE, e.g., the first UE 121, may monitor paging messages, and may power down according to the second DRX configuration, and monitor certain monitoring occasions relating to the multicast session. This may apply to RRC CONNECTED UEs only, to RRC INACTIVE UEs only or to UEs in both RRC states, e.g., the first UE 121 and/or the second UE 122. When the UE, e.g., the first UE 121, considers the session state to be activated, the UE may monitor paging messages and the multicast session according to the first DRX configuration.

In some embodiments, for a session activation notification, a single group paging may be transmitted. It can however happen that the UE, e.g., the first UE 121, fails to detect the group paging.

In some embodiments, if the UE, e.g., the first UE 121, receives the single group paging message, the UE may immediately apply its first DRX configuration, and then receive multicast, as expected, with no lost data. In some embodiments, if the UE, e.g., the first UE 121, misses the single group paging message, the UE can nevertheless detect that the session is activated by receiving multicast session data via its second DRX. I.e. the UE will, e.g., periodically, according to the second DRX configuration, listen for session data transferred in the multicast session to detect whether or not the session is activated. When such detection of an activated multicast session is achieved, the UE may immediately switch to the first DRX configuration and continue multicast reception using the first DRX configuration.

In some embodiments herein, the UE, e.g., the first UE 121 and/or the second UE 122, may therefore detect multicast session activation by the first occurring of the two events: “detected group paging” and “self-detection using the second DRX configuration”. When the UE, e.g., the first UE 121, detects group paging, the UE detects that the multicast session is activated and therefore self-detection is not needed and may not be used.

A network node according to embodiments herein, e.g., the network node 110, such as a gNB may need to ensure that the second DRX configuration has Monitoring Occasions (MOs) such that the UE, e.g., the first UE 121, may detect session data in the multicast session when using the second DRX configuration. In other words, the network node 110 may need to schedule and/or transmit session data in the multicast session such that the UE, by operating under the second DRX, and when listening for session data in the multicast session, e.g., monitoring the multicast session, will necessarily detect data transferred therein such that it is implicit that the multicast session has been activated, e.g., as otherwise no session data can be transferred in the multicast session.

As the second DRX configuration has longer cycle time and/or less monitoring required than the first DRX configuration, the UE, e.g., the first UE 121, will reduce power consumption as it can be in the second DRX configuration much longer, and still be able to receive session data, e.g., in an inactive mobility state such as RRC INACTIVE, when the multicast session is activated.

It shall be noted that a session as used herein may mean a multicast session between a network node 110 and a group of UEs 121, 122. The session may be a multicast, MBS, session.

It shall further be noted that for any embodiments herein, session activation notification may mean any transmitted indication or information indicating that a corresponding multicast session is activated.

It shall further be noted that for any embodiments herein, a session identifier may mean a TMGI, however, when TMGI is used, it may merely be used as an example and any suitable session identifier for a generic multicast session may also be applicable.

Since the UE, e.g., the first UE 121, of embodiments herein may detect that a multicast session is activated either by group paging or by monitoring the session for session data using the second DRX configuration, the robustness of session activation notification will be increased without imposing overhead e.g., by repeating group paging repetition, for the UE. Furthermore, embodiments herein allow the UE, e.g., the first UE 121, to operate in the second DRX configuration when the session is deactivated, and thereby the UE power consumption may be reduced, e.g., compared to operating normally without DRX and/or compared to operating under the first DRX configuration.

By the network configuring a UE, e.g., the first UE 121 or the second UE 122, with two DRXs (DRX1, DRX2), the UE may self-detect that a multicast MBS session is activated. This is since if the UE, e.g., the first UE 121 or the second UE 122, misses a first group paging message, the UE may instead “self-detect” that the multicast session is activated by detecting session data in the multicast session. This implies that the multicast session is activated. This may be done with far lower power consumption than only using DRX1 and with only marginally higher power consumption than only monitoring group paging. The configuration(s) may be applicable to RRC CONNECTED only, RRC INACTIVE only, or to both RRC states, i.e., both RRC CONNECTED and RRC INACTIVE.

The self-detection may be used as a reliable fallback method to a main session notification method, which is group paging, which main session notification method may then be used without repetition. The self-detection method may also be used without group paging (with more lost data) or combined with repeated group paging, (for increased reliability).

A number of embodiments will now be described, some of which may be seen as alternatives, while some may be used in combination.

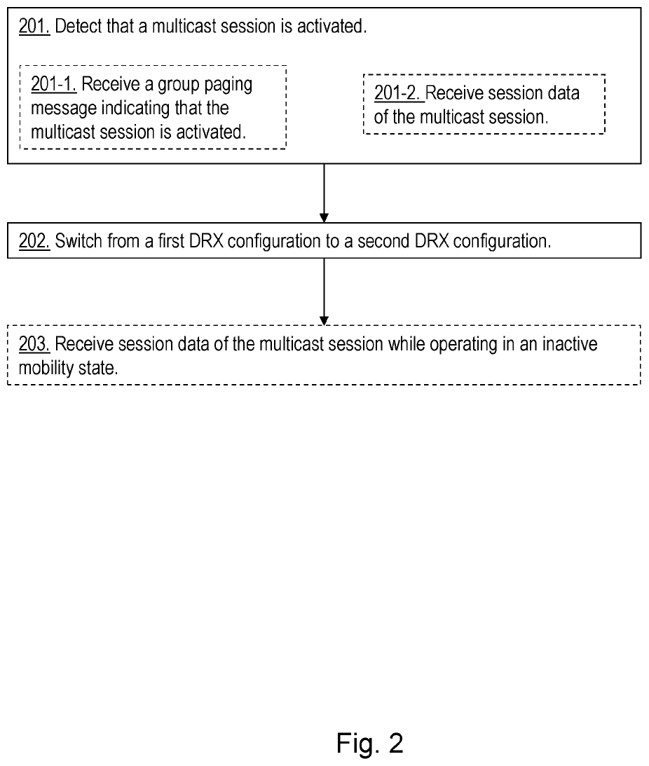

FIG. 2 shows example embodiments of a method performed by the first UE 121 for handling a multicast session between the network node 110 and a group of UEs 121, 122 comprising at least the first UE 121, in the wireless communications network 100. The multicast session may be a multicast MBS session. The first UE 121 operates under a second DRX configuration, e.g., at least initially. The method comprises the following actions, which actions may be taken in any suitable order. Dashed boxes in FIG. 2 may comprise optional actions.

### Action 201

The first UE 121 detects that the multicast session is activated by any one of actions 201-1 or 201-2 below. If detected by any of the actions, the other action is not needed to detect that the multicast session is activated.

### Action 201-1

In some embodiments, the first UE 121 detects that the multicast session is activated by receiving a group paging message to the group of UEs 121, 122 indicating that the multicast session is activated. The first UE 121 may receive the group paging message from the network node 110 in any suitable manner.

### Action 201-2

In some embodiments, the first UE 121 detects that the multicast session is activated by receiving session data of the multicast session.

In some embodiments, the first UE 121 does not receive the group paging message to the group of UEs 121, 122, e.g., as in action 201-1. In these embodiments, when the first UE 121 receives the session data of the multicast session, the received session data implies to the first UE 121 that the multicast session has been activated. This may further imply that the first UE 121 has failed in receiving the group paging message. In this way, the first UE 121 may detect that the multicast session has been activated even when the group paging message is missed.

In some embodiments, the network node 110 is transmits at least some of the session data during monitoring occasions of the second DRX configuration operated by the UE 121 such that the first UE 121 may receive the session data soon after the group paging message, e.g., if the first UE 121 misses the group paging message. This may mean that the first UE 121 receives the session data a predetermined maximum number of slots after the group paging message is transmitted by the first network node 110.

### Action 202

In response to detecting that the multicast session is activated, the first UE 121, switches from the second DRX configuration to a first DRX configuration, e.g., as defined above. The switching allows the first UE 121 to receive the session data in the multicast session transmitted by the network node 110. This is since the network node 110 may transmit the session data to be receivable fully when the UE 121 operates using the first DRX configuration and only partially when the UE 121 operates using the second DRX configuration.

When the first UE 121 operates under the first DRX configuration, the first DRX configuration indicates that the first UE 121 shall monitor all session data transmitted in the multicast session. The second DRX configuration indicates that the first UE 121 shall monitor a subset of all the session data transmitted in the multicast session.

Additionally or alternatively, when the first UE 121 operates under the first DRX configuration, the first UE 121 may monitor the multicast session during a first set of Monitoring Occasions (MOS), and may refrain from monitoring the multicast session during a first cycle time.

When the first UE 121 operates under the second DRX configuration, the first UE 121 may monitor the session during a second set of MOs, and may refrain from monitoring the multicast session during a second cycle time. The second cycle time is longer than the first cycle time. The first set of MOs comprises the second set of MOs. In this example, this means that the monitoring performed by the second DRX configuration is also performed by the first DRX configuration. This further means that the MOs of the second DRX configuration is a subset of the MOs of the first DRX configuration. In other words, when operating under the first DRX configuration, the first UE 121 may receive the same and more data than when operating under the second DRX configuration.

In some embodiments, the second set of MOs is structured to comprise at least at least one part of MOs mapped to adjacent slots in a radio frame. This allows the network node 110 to be more flexible in where/when to transmit session data.

In some embodiments, the first UE 121 is configured to operate in an inactive mobility state, e.g., a Radio Resource Control, RRC, Inactive state. The first UE 121 may detect the session activation and receive the session data in the inactive mobility state.

### Action 203

In some embodiments, when the first UE 121 has switched to the first DRX configuration, the first UE 121 receives session data of the multicast session while operating in the inactive mobility state, e.g., RRC Inactive.

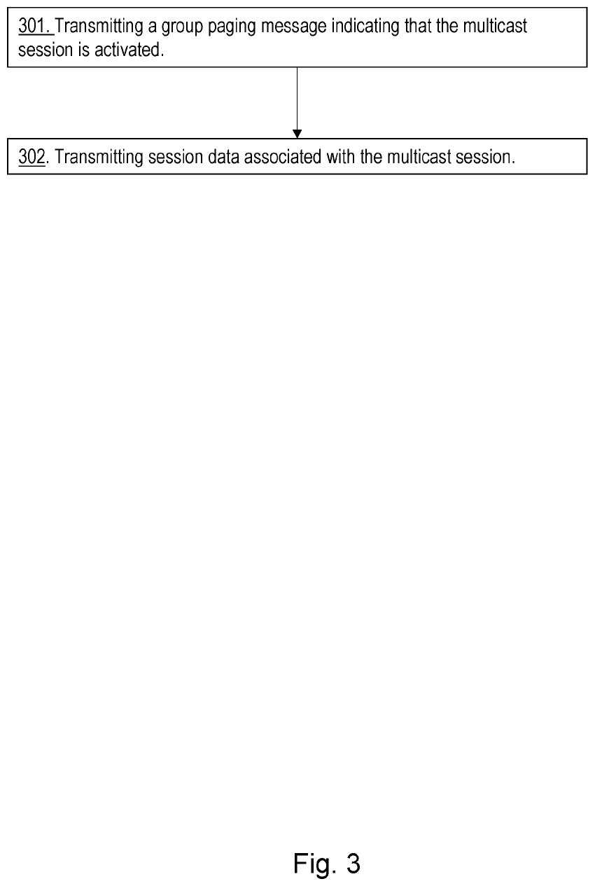

FIG. 3 shows example embodiments of a method performed by a network node 110 for handling a multicast session between the network node 110 and a group of UEs 121, 122 comprising at least the first UE 121, in the wireless communications network 100. The multicast session may be a multicast MBS session. The first UE 121 operates under a second DRX configuration, e.g., at least initially. The method comprises the following actions, which actions may be taken in any suitable order. Actions that are optional are presented in dashed boxes in FIG. 3.

### Action 301

The network node 110 transmits to the group of UEs 121, 122, a group paging message indicating that the multicast session is activated.

### Action 302

The network node 110 transmits to the group of UEs 121, 122, session data associated with the multicast session. The session data is transmitted to be at least partly receivable by the first UE 121 operating under the second DRX configuration and thereby further indicating to the first UE 121 that the multicast session is activated.

In some embodiments, transmitting the session data associated with the multicast session implies to the first UE 121 that the multicast session has been activated, e.g., if the first UE 121 has failed in receiving the transmitted 301 group paging message. In other words, if the first UE 121, misses the transmission of the group paging message in action 301, the receiving of the transmitted session data associated with the multicast session implies to the first UE 121 that the multicast session has been activated, e.g., as otherwise no session data would be transmitted in the session.

The first UE 121 may be configured to be able to selectively operate under a first DRX configuration or the second DRX configuration, e.g., as in actions 201-203.

When the first UE 121 operates under the first DRX configuration, the first UE 121 may monitor the multicast session during a first set of MOs, and may refrain from monitoring the multicast session during a first cycle time.

When the first UE 121 operates under the second DRX configuration, the first UE 121 may monitor the session during a second set of MOs, and may refrain from monitoring the multicast session during a second cycle time. The second cycle time is longer than the first cycle time. The first set of MOs comprises the second set of MOs. In this example, this means that the monitoring performed by the second DRX configuration is also performed by the first DRX configuration. This further means that the MOs of the second DRX configuration is a subset of the MOs of the first DRX configuration. In other words, when operating under the first DRX configuration, the first UE 121 may receive the same and more data than when operating under the second DRX configuration.

In some embodiments, the second set of MOs is structured to comprise at least at least one part of MOs mapped to adjacent slots in a radio frame. This allows the network node 110 to be more flexible in where/when to transmit session data.

In some embodiments, the first UE 121 is configured to operate in an inactive mobility state, e.g., a Radio Resource Control, RRC, Inactive state. The first UE 121 may detect the session activation and receive the session data in the inactive mobility state.

The methods will now be further explained and exemplified in below embodiments. The embodiments may be combined in any suitable manner.

The first UE 121 may be configured with two alternative DRX configurations to be used to receive session data in a multicast session such as a multicast MBS session, the first DRX configuration also referred to as DRX2, and a second DRX configuration also referred to as DRX2. The second DRX configuration may have a longer cycle time than the first DRX configuration. The first UE 121 may be capable of switching between the first and second DRX configurations, e.g., as in action 202. When the multicast session is deactivated, the first UE 121 may switch to the second DRX configuration. When the multicast session is detected to be activated, e.g., as in action 201, the first UE 121 may switch to the first DRX configuration.

In some embodiments, when the first UE 121 considers, e.g., detects that, the session state is, or is to be deactivated for the multicast session, the first UE 121 monitors group paging for the multicast session, e.g., as in action 201-1, but also monitors the multicast session itself for session data indicating that the multicast session is activated, e.g., as in action 201-2. Monitoring the multicast session may be performed according to the second DRX configuration.

In some embodiments, when the first UE 121 considers, e.g., detects that, the session state for the multicast session is, or is to be activated, the first UE 121 may monitor the multicast session according to the first DRX configuration.

For session activation notification, a single group paging may be transmitted to the first UE 121 from the network node 110, e.g., as in action 301. The session activation notification may be sent as a group paging message to a group of UEs comprising the first UE 121, and optionally the second UE 122. The group of UEs 121, 122 may comprise any suitable mix of Rel-17 and Rel-18 UEs. The Rel-17 UEs may always switch to RRC connected when seeing a group page message. If the first UE 121 receives the single group paging, e.g., as in action 201-1, the first UE 121 may immediately apply its first DRX configuration and may then receive multicast in the multicast session, e.g., in RRC INACTIVE, as expected.

If the first UE 121 misses the single group paging, it can nevertheless indirectly detect that the session is activated from reception of multicast session data using its second DRX configuration, e.g., as in action 201-2. When such indirect detection is achieved, the first UE 121 may immediately switch to the first DRX configuration e.g., as in action 202. The first UE 121 may then continue multicast reception using the first DRX configuration, e.g., in RRC inactive.

The network node 110 may need to ensure that the scheduling of multicast session data and configuration of second DRX configuration are coordinated such that the first UE 121 is able to detect at least some session data when using second DRX configuration and the multicast session is activated and when session data is transmitted in the multicast session. In other words, the network node 110, e.g., as part of action 302, may need to schedule the multicast session data, e.g., MBS session data, such that the first UE 121 operating using the second DRX configuration shall detect the transmitted session data.

The first UE 121 may in the first or second DRX configuration be in RRC Inactive, while RRC connected being an option. Using RRC inactive reduced power consumption of the first UE 121, but will be slightly higher than only monitoring group paging. When using the second DRX configuration, the power consumption of the first UE 121 is reduced compared to using the first DRX configuration.

As an example scenario of embodiments herein, the cycle time of second DRX configuration may be far larger than that of first DRX configuration, e.g., greater than a threshold. With an example application such as Mission Critical Push To Talk (MCPTT), which typically uses one transmitted audio frame per 20 milliseconds (ms), corresponding to, on average, one transmitted Transport Block (TB) per 20 ms, the cycle time of the first DRX configuration may e.g. be 10 ms, e.g., when the first UE 121 would be in power saving and/or not monitor certain radio. This allows for scheduling a TB containing an audio frame every 20 ms, with allowance for an alternative scheduling of +/−10 ms, for the first UE 121 to be able to receive the audio frame. In contrast, the second DRX configuration may be in the order of 500 ms, allowing for a factor 50 lower power consumption compared to using first DRX configuration when considering the monitoring of radio frames, e.g., besides monitoring of POs for group paging which may be added power consumption over monitoring of the multicast session according to the first and second DRX configurations. As an example, if the cycle time of the POs for monitoring group paging messages, e.g., as transmitted in action 301, is e.g. 100 ms, this means a total power consumption due to monitoring according to second DRX configuration and group paging monitoring is only marginally larger than by only monitoring paging. This is since the second DRX configuration rarely monitors the session data of the multicast session and POs of the group paging is the majority of monitoring occasions.

When the first UE 121 receives the (single) group paging, e.g., as in action 201-1, there is no loss of data as the UE 121 may directly start to monitor the session data in the multicast session e.g., using the first configuration, as in actions 202-203. If the first UE 121 misses the group paging, e.g., as sent by the network node 110 in action 301, but detects session activation via second DRX configuration, e.g., as in action 201-2, the multicast session may then have been going on for a maximum period of the cycle time of second DRX configuration. It may be assumed that the first UE 121 may not miss both group paging, e.g., as transmitted in action 301, and the subsequent multicast session data, e.g., as transmitted in action 302, in the immediately following second DRX configuration monitoring occasion. This is since the probability to miss group paging and following session data is extremely low, e.g., lower than a threshold, when the first UE 121 is within coverage of the network node 110.

In some scenarios, to allow time for when UEs in the group of UEs 121, 122, e.g., other than the first UE 121, is in RRC INACTIVE, and is group paged, e.g., as in action 301, and at least some UEs are expected to resume to RRC CONNECTED before receiving session data, e.g., as transmitted in action 302, session data transmission may be delayed by the network node 110, e.g., as in action 302, until the one or more UEs of the group of UEs 121, 122, is ready to receive data in RRC CONNECTED. The delay may be predetermined. If this delay is, 200 ms, it means that the first UE 121 in RRC INACTIVE, when missing the group paging, will receive data no more than 300 ms later than UEs in the group of UEs 121, 122 that received group paging and resumed to RRC CONNECTED. This is since if the monitoring occasions for the second DRX configuration, e.g., as operated by the first UE 121, has a cycle time of 500 ms, i.e. the first UE 121 checks for session data in the multicast session every 500 ms, then the first UE 121 may check for session data in the multicast session just before the group paging message, and subsequently after 200 ms, the session data is started for the multicast session, then after additional 300 ms, 500 ms have passed since the last monitoring, and thereby the first UE 121 may receive the session data for the multicast session, e.g., as in action 201-2. In other words, a difference between the cycle time of the second DRX configuration and the predetermined delay may be the longest transmission time missed by the first UE 121, and the network node 110, the first UE 121, and/or applications used by them may account for this, e.g., when planning how and when to send critical data to the first UE 121.

However, if group paging is performed at a time that is independent of the second DRX configuration monitoring occasions, the first UE 121, in RRC INACTIVE, that has missed the group paging, will—on average—receive the session data only 50 ms later than resuming UEs, if the cycle time of the second DRX configuration is 500 ms. This is since on average, the paging occasion is in the middle of the cycle time of the second DRX configuration. It should be noted that this amount of missed data only affects UEs that missed the group paging. In examples herein, mostly the first UE 121 is discussed, however, the skilled person understands that the same applies for any number of UEs with similar or same configurations.

In some embodiments, the network node 110 may coordinate a start of session data transmission, e.g., as in action 302, with the second DRX configuration monitoring occasions such that second DRX configuration monitoring occasion will occur simultaneously with the first transmitted data of the session data transmitted by the network node 110, e.g. as in action 302, or as little time as possible following the first transmission, e.g., the time being smaller than a threshold.

It may further be noted that UEs in the group of UEs 121, 122, that are group paged to resume to RRC CONNECTED may however also miss group paging, at least to the same extent as UEs that are expected to stay in RRC INACTIVE, e.g., the first UE 121. The network node 110 may have knowledge of which UEs are expected to resume to RRC Connected. Since there will be a delay before the network node 110 detects the missing UEs, assuming these UEs will receive a repeated paging, they may also miss some data in the beginning of the activation period. This means that the amount of lost data for the first UE 121, performing self-detection as in actions 201-1 or 201-2, is not necessarily larger than for UEs that need to resume to RRC CONNECTED. In some scenarios, the first UE 121 may in fact, on average have a lower loss of data on average than UEs expected to always resume to an RRC connected state. This is since even if the first UE 121 misses the group paging, it is likely that it will detect session activation quickly. However, the UEs expected to always resume to an RRC connected state will always have a significant delay before resumption to RRC connected.

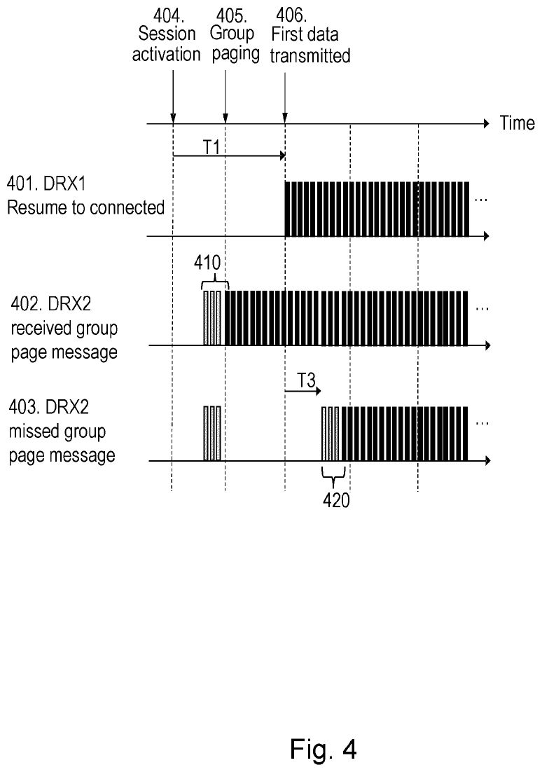

FIG. 4 illustrates an example scenario of embodiments herein by comparing UEs in the group of UEs 121, 122, in three example situations. A first example scenario 401, wherein a DRX1 UE in the group of UEs 121, 122, receives a group paging message transmitted by the network node 110, e.g., as in action 301, and resumes to RRC CONNECTED to receive the session data, i.e. the top part of the illustration of FIG. 4.

The DRX1 UE may initially be in RRC INACTIVE, and when group paged, the DRX1 UE may resume to RRC CONNECTED to operate under the first DRX configuration.

Subsequently after sending a session activation 404, the network node 110 may send the group paging message 405, e.g., as in action 301, and as the network node 110 knows that the DRX1 UE need to resume to RRC CONNECTED, the network node 110 may need to delay the transmission of session data in the multicast session. The network node 110 may then transmit the first data 406 as part of the multicast session data, a T1 time period after the session activation 404.

A second example scenario 402, wherein the first UE 121 is group paging and stays in RRC INACTIVE to receive data, i.e. the middle part of the illustration of FIG. 4. The first UE 121 receives the group paging message 405, e.g., as in action 201-1, in one or more monitoring occasions 410. The monitoring occasions 410 may be the monitoring occasions of the second DRX configuration and/or paging occasions for the paging messages. The first UE 121 switches to the first DRX configuration, e.g., as in action 202, and when the network node 110 then transmit the first data 406 as part of the multicast session data, the first UE 121 will receive the data as it is in the first DRX configuration and monitors the occasions which the session data for the multicast session is transmitted on.

A third example scenario 403, the first UE 121 misses group paging but self-detects session activation, i.e., the bottom part of the illustration of FIG. 4. The first UE 121 misses the group paging message 405, e.g., as transmitted by the network node 110 in action 301.

In this third scenario 403, the first UE 121 will then after the network node 110 has n transmitted the first data 406, notice during one or more monitoring occasions 420 that there is session data transmitted in the multicast session, e.g., as in action 201-2. The first UE 121 may then switch to the first DRX configuration, e.g., as in action 202, and continue to receive the multicast data in RRC inactive, e.g., as in action 203.

To allow for some scheduling flexibility for the network node 110, while still ensuring that the first UE 121 may self-detect session activation just using its second DRX configuration, e.g., as in action 201-2, the second DRX configuration may be configured to take this into account. In one embodiment, the second DRX configuration may be configured with a structure of monitoring occasions (MOs) which structure has MOs in a few adjacent slots, e.g., in a radio frame, followed by a large gap, e.g., the cycle time of the second DRX configuration, followed again by a few such adjacent slots, e.g., repeating as a pattern. In this way the network node 110 has the flexibility to adjust scheduling from a nominal default slot to any of the immediately adjacent slots. This embodiment does not exclude other second DRX configuration patterns and any other DRX configurations may apply, e.g., wherein the power saving of the second DRX configuration is greater than the first DRX configuration. The configuration of second DRX configuration may be flexible enough to allow for arbitrary, but at least multiple, different second DRX configuration patterns.

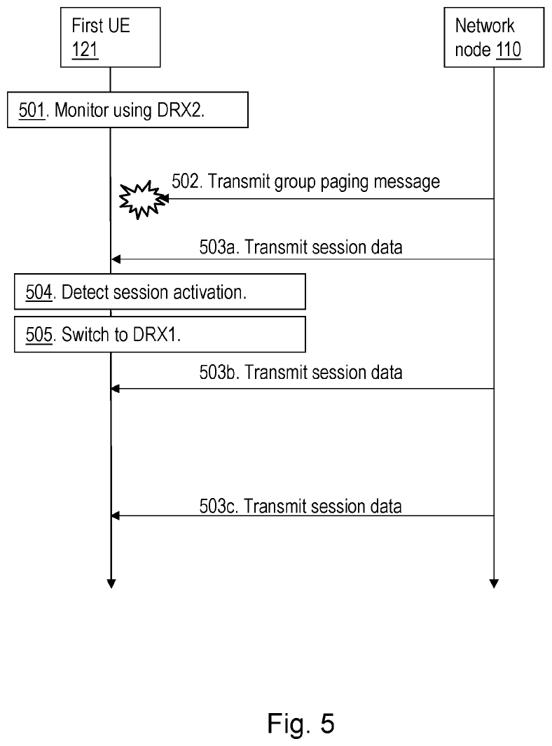

FIG. 5 illustrates an example scenario of embodiments herein, communication between the first UE 121 and the network node 110 is illustrated as a combined flowchart and sequence diagram.

In the example scenario, the first UE 121 monitors 501 a multicast session using the second DRX configuration.

In the example scenario, the network node 110 transmits 502 a group paging message to a group of UEs including the first UE 121, e.g., as in action 301. The group paging message being associated with the multicast session being activated. In other words, the group paging message indicated that the multicast session is activated.

In this example scenario, the first UE 121 misses the group paging message. In other words, the first UE 121 does not receive nor detect the group paging message.

In the example scenario, the network node 110 transmits 503a-c session data, e.g., as in action 302, such that it is receivable by a UE operating under the first DRX configuration.

The first UE 121 receives session data from transmission 503a, which is also receivable by the second DRX configuration, and may consequently detect 504 the session activation, e.g., as in action 201-2.

In the example scenario, the first UE 121 then switches 505 to the first DRX configuration, e.g., as in action 202.

In the example scenario, the first UE 121 then operates under the first DRX configuration and may then receive session data from transmissions 503b-c, e.g., which transmissions may not be receivable when operating under the second DRX configuration.

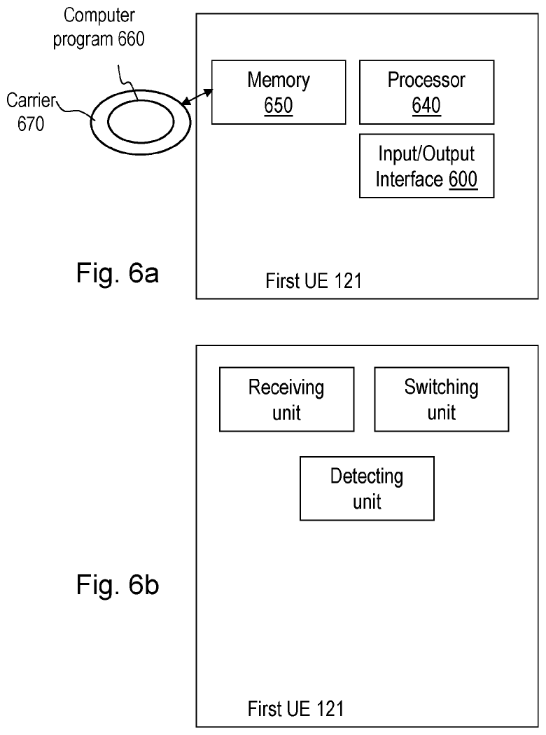

To perform the method actions above, the first UE 121 may comprise an arrangement depicted in FIGS. 6a and 6b. The first UE 121 is configured to handle a multicast session between the network node 110 and a group of UEs 121, 122 comprising at least the first UE 121 in the wireless communications network 100. The multicast session may be a multicast MBS session. The first UE 121 is configured to operate under the second DRX configuration, e.g., at least initially.

The first UE 121 may comprise an input and output interface 600 configured to communicate with any suitable entity described herein, e.g., the network node 110. The input and output interface 600 may comprise a wireless receiver not shown, and a wireless transmitter not shown.

The first UE 121 may further comprise any one or more out of: a receiving unit, a switching, and a detecting unit, e.g., to perform the actions above.

The first UE 121 is configured to detect that the multicast session is activated by any one of: receive, a group paging message to the group of UEs 121, 122 indicating that the multicast session is activated, or by receive, session data of the multicast session.

The first UE 121 is configured to, in response to detecting that the multicast session is activated, switch, from the second DRX configuration to a first DRX configuration, wherein the first DRX configuration is adapted to indicate that the first UE 121 shall monitor all session data transmitted in the multicast session. The second DRX configuration is adapted to indicate that the first UE 121 shall monitor a subset of all the session data transmitted in the multicast session.

In some embodiments, the first DRX configuration is adapted to comprise: monitoring the multicast session during a first set of MOs and refraining from monitoring the session during a first cycle time. In some of these embodiments, the second DRX configuration is adapted to comprise: monitoring the session during a second set of MOs, and refraining from monitoring the session during a second cycle time. The second cycle time may be adapted to be longer than the first cycle time. The first set of MOs may be adapted to comprise the second set of MOs.

In some embodiments, the second set of MOs is adapted to be structured to comprise at least at least one part of MOs mapped to adjacent slots in a radio frame.

In some embodiments, first UE 121 is configured to operate in an inactive mobility state and further configured to: when the first UE 121 has switched to the first DRX configuration, receive session data of the multicast session while operating in the inactive mobility state.

In some embodiments, first UE 121 is configured to when the first UE 121 has not received the group paging message to the group of UEs 121, 122, receiving the session data of the multicast session implies to the first UE 121 that the multicast session has been activated. The embodiments herein may be implemented through a processor or one or more processors, such as at least one processor 640 of a processing circuitry in the first UE 121 depicted in FIG. 6a, together with computer program code for performing the functions and actions of the embodiments herein. The program code mentioned above may also be provided as a computer program product, for instance in the form of a data carrier carrying computer program code for performing the embodiments herein when being loaded into the first UE 121. One such carrier may be in the form of a CD ROM disc. It is however feasible with other data carriers such as a memory stick. The computer program code may furthermore be provided as pure program code on a server and downloaded to the first UE 121.

The first UE 121 may further comprise respective a memory 650 comprising one or more memory units. The memory comprises instructions executable by the processor in the first UE 121. The memory is arranged to be used to store instructions, data, configurations, and applications to perform the methods herein when being executed in the first UE 121.

In some embodiments, a computer program 660 comprises instructions, which when executed by the at least one processor, cause the at least one processor of the first UE 121 to perform the actions above.

In some embodiments, a respective carrier 670 comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the first UE 121, described below may refer to a combination of analog and digital circuits, and/or one or more processors configured with software and/or firmware, e.g. stored in the first UE 121, that when executed by the respective one or more processors such as the at least one processor described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

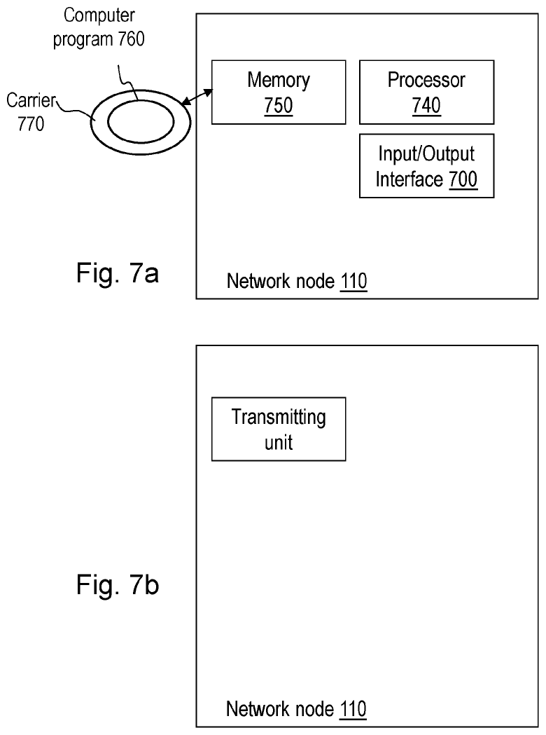

To perform the method actions above, the network node 110 may comprise an arrangement depicted in FIGS. 7a and 7b. The network node 110 is configured to handle a multicast session between the network node 110 and a group of UEs 121, 122 comprising at least the first UE 121 in the wireless communications network 100. The multicast session may be a multicast MBS session. The first UE 121 may be adapted to operate under the second DRX configuration, e.g., at least initially.

The network node 110 may comprise an input and output interface 700 configured to communicate with any suitable entity described herein, e.g., the network node 110. The input and output interface 700 may comprise a wireless receiver not shown, and a wireless transmitter not shown.

The network node 110 may further comprise any one or more out of: a receiving unit, a deriving unit, and a configuring unit, e.g., to perform the actions above.

The network node 110 is configured to transmit to the group of UEs 121, 122, a group paging message indicating that the multicast session is activated.

The network node 110 is configured to transmit session data associated with the multicast session. The session data is transmitted to be at least partly receivable by the first UE 121 operating under the second DRX configuration, and thereby further indicating to the first UE 121 that the multicast session is activated.

In some embodiments the first UE 121 is configured to be able to selectively operate under a first DRX configuration or the second DRX configuration. In some embodiments, when the first UE 121 operates under the first DRX configuration, the first UE 121 monitors the multicast session during a first set of MOs, and refrains from monitoring the session during a first cycle time. In some embodiments, when the first UE 121 operates under the second DRX configuration, the first UE 121 monitors the session during a second set of MOs, and refrains from monitoring the session during a second cycle time. The second cycle time may be adapted to be longer than the first cycle time., The first set of MOs may be adapted to comprise the second set of MOs.

In some embodiments, the second set of MOs is adapted to be structured to comprise at least at least one part of MOs mapped to adjacent slots in a radio frame.

In some embodiments, the first UE 121 is adapted to be configured to operate in an inactive mobility state.

In some embodiments, transmitting the session data associated with the multicast session implies to the first UE 121 that the multicast session has been activated.

The embodiments herein may be implemented through a processor or one or more processors, such as at least one processor 740 of a processing circuitry in the network node 110 depicted in FIG. 7a, together with computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise respective a memory 750 comprising one or more memory units. The memory comprises instructions executable by the processor in the network node 110. The memory is arranged to be used to store instructions, data, configurations, and applications to perform the methods herein when being executed in the network node 110.

In some embodiments, a computer program 760 comprises instructions, which when executed by the at least one processor, cause the at least one processor of the network node 110 to perform the actions above.

In some embodiments, a respective carrier 770 comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the network node 110, described below may refer to a combination of analog and digital circuits, and/or one or more processors configured with software and/or firmware, e.g. stored in the network node 110, that when executed by the respective one or more processors such as the at least one processor described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

### EMBODIMENTS

Below, some example embodiments 1-20 are shortly described. See e.g. FIGS. 1, 2, 3, 4, 5, 6a, 6b, 7a, and 7b.

Embodiment 1. A method performed by a first UE 121 for handling a multicast session between a network node 110 and a group of UEs 121, 122 comprising at least the first UE 121, in a wireless communications network 100, e.g. wherein the multicast session is a multicast, Multicast Broadcast Service, MBS, session, wherein the first UE 121 operates under a second Discontinuous Reception, DRX, configuration, the method e.g., comprising any one or more out of:
detecting 201 that the multicast session is activated by any one of: receiving 201-1 a group paging message to the group of UEs 121, 122 indicating that the multicast session is activated, or by receiving 201-2 session data of the multicast session,
in response to detecting 201 that the multicast session is activated, switching 202 from the second DRX configuration to a first DRX configuration, wherein the first DRX configuration indicates that the first UE 121 shall monitor all session data transmitted in the multicast session, and wherein the second DRX configuration indicates that the first UE 121 shall monitor a subset of all the session data transmitted in the multicast session,
optionally, the first DRX configuration comprises monitoring the multicast session during a first set of Monitoring Occasions, MOs, and refraining from monitoring the session during a first cycle time, and wherein the second DRX configuration comprises monitoring the session during a second set of MOs, and refraining from monitoring the session during a second cycle time, wherein the second cycle time is longer than the first cycle time, and wherein the first set of MOs comprises the second set of MOs.

Embodiment 2. A method according to Embodiment 1, wherein the second set of MOs is structured to comprise at least at least one part of MOs mapped to adjacent slots in a radio frame.

Embodiment 3. A method according to any one of Embodiments 1-2, wherein the first UE 121 is configured to operate in an inactive mobility state, e.g., a Radio Resource Control, RRC, Inactive state, and wherein the method further comprising:
when the first UE 121 has switched 202 to the first DRX configuration, receiving 203 session data of the multicast session while operating in the inactive mobility state.

Embodiment 4. A method according to any one of Embodiments 1-3, wherein when the first UE 121 has not received 201-1 the group paging message to the group of UEs 121, 122, receiving 201-2 the session data of the multicast session implies to the first UE 121 that the multicast session has been activated, e.g., and further implies that the first UE 121 has failed in receiving the group paging message.

Embodiment 5. A method performed by a network node 110 for handling a multicast session between the network node 110 and a group of UEs 121, 122 comprising at least a first UE 121, in a wireless communications network 100, e.g. wherein the multicast session is a multicast, Multicast Broadcast Service, MBS, session, and wherein the first UE 121 operates under a second Discontinuous Reception, DRX, configuration, the method e.g., comprising any one or more out of:
transmitting 301 to the group of UEs 121, 122, a group paging message indicating that the multicast session is activated, and
transmitting 302 to the group of UEs 121, 122, session data associated with the multicast session, the session data being transmitted to be at least partly receivable by the first UE 121 operating under the second DRX configuration, and thereby further indicating to the first UE 121 that the multicast session is activated,
optionally, the first UE 121 is configured to be able to selectively operate under a first DRX configuration or the second DRX configuration, and when the first UE 121 operates under the first DRX configuration, the first UE 121 monitors the multicast session during a first set of Monitoring Occasions, MOs, and refrains from monitoring the session during a first cycle time, and when the first UE 121 operates under the second DRX configuration, the first UE 121 monitors the session during a second set of MOs, and refrains from monitoring the session during a second cycle time, wherein the second cycle time is longer than the first cycle time, and wherein the first set of MOs comprises the second set of MOs.

Embodiment 6. A method according to Embodiment 5, wherein the second set of MOs is structured to comprise at least at least one part of MOs mapped to adjacent slots in a radio frame.

Embodiment 7. A method according to any one of Embodiments 5-6, wherein the first UE 121 is configured to operate in an inactive mobility state, e.g., a Radio Resource Control, RRC, Inactive state.

Embodiment 8. A method according to any one of Embodiments 5-7, wherein transmitting 302 the session data associated with the multicast session implies to the first UE 121 that the multicast session has been activated, e.g., if the first UE 121 has failed in receiving the transmitted 301 group paging message.

Embodiment 9. A computer program 660 comprising instructions, which when executed by a processor 640, causes the processor 640 to perform actions according to any of the Embodiments 1-4.

Embodiment 10. A carrier 670 comprising the computer program 660 of Embodiment 9, wherein the carrier 670 is one of an electronic signal, an optical signal, an electromagnetic signal, a magnetic signal, an electric signal, a radio signal, a microwave signal, or a computer-readable storage medium.

Embodiment 11. A computer program 760 comprising instructions, which when executed by a processor 740, causes the processor 740 to perform actions according to any of the Embodiments 5-8.

Embodiment 12. A carrier 770 comprising the computer program 760 of Embodiment 11, wherein the carrier 770 is one of an electronic signal, an optical signal, an electromagnetic signal, a magnetic signal, an electric signal, a radio signal, a microwave signal, or a computer-readable storage medium.

Embodiment 13. A first UE 121 configured to handle a multicast session between a network node 110 and a group of UEs 121, 122 comprising at least the first UE 121, in a wireless communications network 100 e.g. wherein the multicast session is adapted to be a multicast, Multicast Broadcast Service, MBS, session, and wherein the first UE 121 is configured to operate under a second Discontinuous Reception, DRX, configuration, the first UE 121 e.g., further being configured to any one or more out of:
detect, e.g., by means of a detecting unit in the first UE 121, that the multicast session is activated by any one of: receive, e.g., by means of a receiving unit in the first UE 121, a group paging message to the group of UEs 121, 122 indicating that the multicast session is activated, or by receive, e.g., by means of the receiving unit in the first UE 121, session data of the multicast session,
in response to detecting that the multicast session is activated, switch, e.g., by means of a switching unit in the first UE 121, from the second DRX configuration to a first DRX configuration, wherein the first DRX configuration is adapted to indicate that the first UE 121 shall monitor all session data transmitted in the multicast session, and wherein the second DRX configuration is adapted to indicate that the first UE 121 shall monitor a subset of all the session data transmitted in the multicast session.
optionally, the first DRX configuration is adapted to comprise: monitoring the multicast session during a first set of Monitoring Occasions, MOs, and refraining from monitoring the session during a first cycle time, and wherein the second DRX configuration is adapted to comprise: monitoring the session during a second set of MOs, and refraining from monitoring the session during a second cycle time, wherein the second cycle time is adapted to be longer than the first cycle time, and wherein the first set of MOs is adapted to comprise the second set of MOs.

Embodiment 14. A first UE 121 according to Embodiment 13, wherein the second set of MOs is adapted to be structured to comprise at least at least one part of MOs mapped to adjacent slots in a radio frame.

Embodiment 15. A first UE 121 according to any one of Embodiments 13-14, further configured to operate in an inactive mobility state, e.g., a Radio Resource Control, RRC, Inactive state, and further configured to:
when the first UE 121 has switched to the first DRX configuration, receive, e.g., by means of the receiving unit in the first UE 121, session data of the multicast session while operating in the inactive mobility state.

Embodiment 16. A first UE 121 according to any one of Embodiments 13-15, wherein when the first UE 121 has not received the group paging message to the group of UEs 121, 122, receiving the session data of the multicast session implies to the first UE 121 that the multicast session has been activated, e.g., and further implies that the first UE 121 has failed in receiving the group paging message.

Embodiment 17. A network node 110 configured to handle a multicast session between the network node 110 and a group of UEs 121, 122 comprising at least a first UE 121 in a wireless communications network 100 e.g. wherein the multicast session is a multicast, Multicast Broadcast Service, MBS, session, and wherein the first UE 121 is adapted to operate under a second Discontinuous Reception, DRX, configuration, network node 110 e.g., further being configured to any one or more out of:
transmit, e.g., by means of a transmitting unit in the network node 110, to the group of UEs 121, 122, a group paging message indicating that the multicast session is activated, and
transmit, e.g., by means of the transmitting unit in the network node 110, session data associated with the multicast session, the session data being transmitted to be at least partly receivable by the first UE 121 operating under the second DRX configuration, and thereby further indicating to the first UE 121 that the multicast session is activated,
optionally, the first UE 121 is configured to be able to selectively operate under a first DRX configuration or the second DRX configuration, and when the first UE 121 operates under the first DRX configuration, the first UE 121 monitors the multicast session during a first set of Monitoring Occasions, MOs, and refrains from monitoring the session during a first cycle time, and when the first UE 121 operates under the second DRX configuration, the first UE 121 monitors the session during a second set of MOs, and refrains from monitoring the session during a second cycle time, wherein the second cycle time is adapted to be longer than the first cycle time, and wherein the first set of MOs is adapted to comprise the second set of MOs.

Embodiment 18. A network node 110 according to Embodiment 17, wherein the second set of MOs is adapted to be structured to comprise at least at least one part of MOs mapped to adjacent slots in a radio frame.

Embodiment 19. A network node 110 according to any one of Embodiments 17-18, wherein the first UE 121 is adapted to be configured to operate in an inactive mobility state, e.g., a Radio Resource Control, RRC, Inactive state.

Embodiment 20. A network node 110 according to any one of Embodiments 17-19, wherein transmitting the session data associated with the multicast session implies to the first UE 121 that the multicast session has been activated, e.g., if the first UE 121 has failed in receiving the transmitted group paging message.

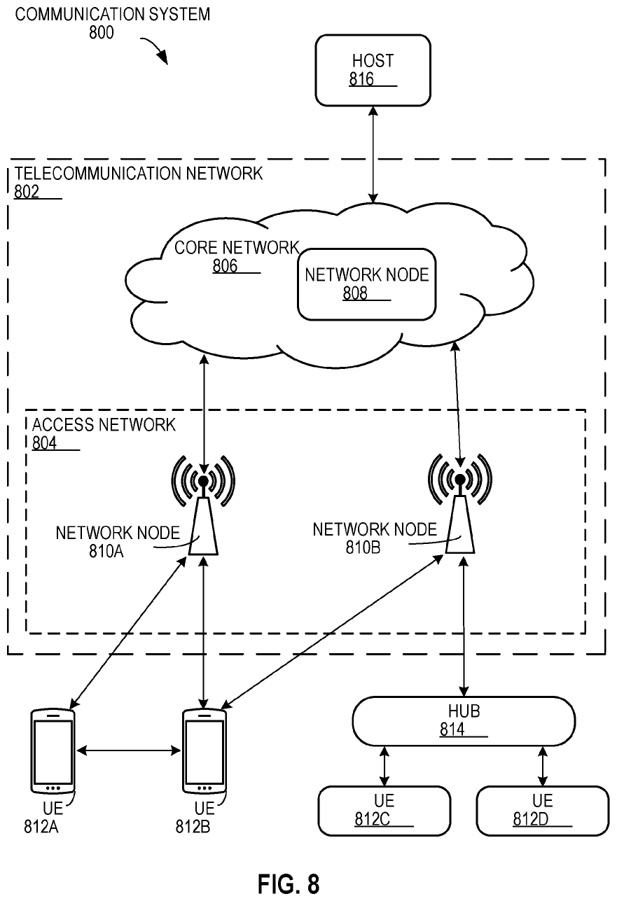

FIG. 8 shows an example of a communication system 800 in accordance with some embodiments. The communication system 800 may be the wireless communications network 100.

In the example, the communication system 800 includes a telecommunication network 802 that includes an access network 804, such as a radio access network (RAN), and a core network 806, which includes one or more core network nodes 808, e.g., the CN node 130. The access network 804 includes one or more access network nodes, such as network nodes 810a and 810b, e.g., the network node 110, (one or more of which may be generally referred to as network nodes 810), or any other similar 3^{rd} Generation Partnership Project (3GPP) access node or non-3GPP access point. The network nodes 810 facilitate direct or indirect connection of user equipment (UE), such as by connecting UEs 812a, 812b, 812c, and 812d (one or more of which may be generally referred to as UEs 812), e.g., the first and/or second UE 121, 122, to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (Wi-Fi); and/or any other appropriate wireless communication standard, such as the Worldwide Interoperability for Microwave Access (WiMAX), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved—UMTS Terrestrial Radio Access Network) New Radio—Dual Connectivity (EN-DC).

In the example, the hub 814 communicates with the access network 804 to facilitate indirect communication between one or more UEs (e.g., UE 812c and/or 812d) and network nodes (e.g., network node 810b). In some examples, the hub 814 may be a controller, router, content source and analytics, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

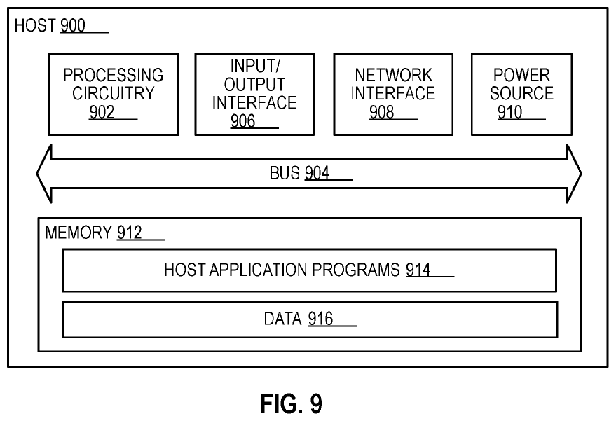

FIG. 9 is a block diagram of a host 900, which may be an embodiment of the host 816 of FIG. 8, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

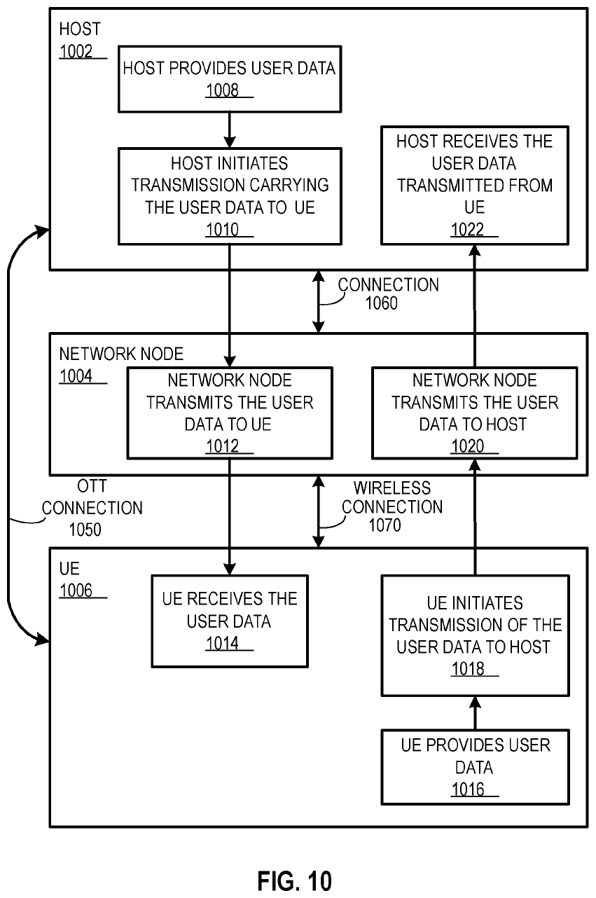

FIG. 10 shows a communication diagram of a host 1002 communicating via a network node 1004 with a UE 1006 over a partially wireless connection in accordance with some embodiments. Example implementations, in accordance with various embodiments, of the UE, network node (such as network node 810a of FIG. 8), and host (such as host 816 of FIG. 8 and/or host 900 of FIG. 9) discussed in the preceding paragraphs will now be described with reference to FIG. 10.

Like host 900, embodiments of host 1002 include hardware, such as a communication interface, processing circuitry, and memory. The host 1002 also includes software, which is stored in or accessible by the host 1002 and executable by the processing circuitry. The software includes a host application that may be operable to provide a service to a remote user, such as the UE 1006 connecting via an over-the-top (OTT) connection 1050 extending between the UE 1006 and host 1002. In providing the service to the remote user, a host application may provide user data which is transmitted using the OTT connection 1050.

The network node 1004 includes hardware enabling it to communicate with the host 1002 and UE 1006. The connection 1060 may be direct or pass through a core network (like core network 806 of FIG. 8) and/or one or more other intermediate networks, such as one or more public, private, or hosted networks. For example, an intermediate network may be a backbone network or the Internet.

The UE 1006 includes hardware and software, which is stored in or accessible by UE 1006 and executable by the UE's processing circuitry. The software includes a client application, such as a web browser or operator-specific “app” that may be operable to provide a service to a human or non-human user via UE 1006 with the support of the host 1002. In the host 1002, an executing host application may communicate with the executing client application via the OTT connection 1050 terminating at the UE 1006 and host 1002. In providing the service to the user, the UE's client application may receive request data from the host's host application and provide user data in response to the request data. The OTT connection 1050 may transfer both the request data and the user data. The UE's client application may interact with the user to generate the user data that it provides to the host application through the OTT connection 1050.

The OTT connection 1050 may extend via a connection 1060 between the host 1002 and the network node 1004 and via a wireless connection 1070 between the network node 1004 and the UE 1006 to provide the connection between the host 1002 and the UE 1006. The connection 1060 and wireless connection 1070, over which the OTT connection 1050 may be provided, have been drawn abstractly to illustrate the communication between the host 1002 and the UE 1006 via the network node 1004, without explicit reference to any intermediary devices and the precise routing of messages via these devices.

As an example of transmitting data via the OTT connection 1050, in step 1008, the host 1002 provides user data, which may be performed by executing a host application. In some embodiments, the user data is associated with a particular human user interacting with the UE 1006. In other embodiments, the user data is associated with a UE 1006 that shares data with the host 1002 without explicit human interaction. In step 1010, the host 1002 initiates a transmission carrying the user data towards the UE 1006. The host 1002 may initiate the transmission responsive to a request transmitted by the UE 1006. The request may be caused by human interaction with the UE 1006 or by operation of the client application executing on the UE 1006. The transmission may pass via the network node 1004, in accordance with the teachings of the embodiments described throughout this disclosure. Accordingly, in step 1012, the network node 1004 transmits to the UE 1006 the user data that was carried in the transmission that the host 1002 initiated, in accordance with the teachings of the embodiments described throughout this disclosure. In step 1014, the UE 1006 receives the user data carried in the transmission, which may be performed by a client application executed on the UE 1006 associated with the host application executed by the host 1002.

In some examples, the UE 1006 executes a client application which provides user data to the host 1002. The user data may be provided in reaction or response to the data received from the host 1002. Accordingly, in step 1016, the UE 1006 may provide user data, which may be performed by executing the client application. In providing the user data, the client application may further consider user input received from the user via an input/output interface of the UE 1006. Regardless of the specific manner in which the user data was provided, the UE 1006 initiates, in step 1018, transmission of the user data towards the host 1002 via the network node 1004. In step 1020, in accordance with the teachings of the embodiments described throughout this disclosure, the network node 1004 receives user data from the UE 1006 and initiates transmission of the received user data towards the host 1002. In step 1022, the host 1002 receives the user data carried in the transmission initiated by the UE 1006.

One or more of the various embodiments improve the performance of OTT services provided to the UE 1006 using the OTT connection 1050, in which the wireless connection 1070 forms the last segment. More precisely, the teachings of these embodiments may improve the power consumption and reduce traffic and thereby provide benefits such as reduced user waiting time, better responsiveness and extended battery lifetime.

In an example scenario, factory status information may be collected and analyzed by the host 1002. As another example, the host 1002 may process audio and video data which may have been retrieved from a UE for use in creating maps. As another example, the host 1002 may collect and analyze real-time data to assist in controlling vehicle congestion (e.g., controlling traffic lights). As another example, the host 1002 may store surveillance video uploaded by a UE. As another example, the host 1002 may store or control access to media content such as video, audio, VR or AR which it can broadcast, multicast or unicast to UEs. As other examples, the host 1002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1050 between the host 1002 and UE 1006, in response to variations in the measurement results. The measurement procedure and/or the network functionality for reconfiguring the OTT connection may be implemented in software and hardware of the host 1002 and/or UE 1006. In some embodiments, sensors (not shown) may be deployed in or in association with other devices through which the OTT connection 1050 passes; the sensors may participate in the measurement procedure by supplying values of the monitored quantities exemplified above, or supplying values of other physical quantities from which software may compute or estimate the monitored quantities. The reconfiguring of the OTT connection 1050 may include message format, retransmission settings, preferred routing etc.; the reconfiguring need not directly alter the operation of the network node 1004. Such procedures and functionalities may be known and practiced in the art. In certain embodiments, measurements may involve proprietary UE signaling that facilitates measurements of throughput, propagation times, latency and the like, by the host 1002. The measurements may be implemented in that software causes messages to be transmitted, in particular empty or ‘dummy’ messages, using the OTT connection 1050 while monitoring propagation times, errors, etc.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

1. A method performed by a first UE for handling a multicast session between a network node and a group of UEs comprising at least the first UE in a wireless communications network, the first UE operating under a second Discontinuous Reception, DRX, configuration, the method comprising:
detecting that the multicast session is activated by any one of: receiving group paging message to the group of UEs indicating that the multicast session is activated, or by receiving session data of the multicast session; and
in response to detecting that the multicast session is activated, switching from the second DRX configuration to a first DRX configuration, the first DRX configuration indicating that the first UE shall monitor all session data transmitted in the multicast session, and the second DRX configuration indicating that the first UE shall monitor a subset of all the session data transmitted in the multicast session.

2. The method according to claim 1, wherein the first DRX configuration comprises monitoring the multicast session during a first set of Monitoring Occasions, MOs, and refraining from monitoring the session during a first cycle time, and wherein the second DRX configuration comprises monitoring the session during a second set of MOs, and refraining from monitoring the session during a second cycle time, wherein the second cycle time is longer than the first cycle time, and wherein the first set of MOs comprises the second set of MOs.

3. The method according to claim 2, wherein the second set of MOs is structured to comprise at least at least one part of MOs mapped to adjacent slots in a radio frame.

4. The method according to claim 1, wherein the first UE is configured to operate in an inactive mobility state, and wherein the method further comprising:
when the first UE has switched to the first DRX configuration, receiving session data of the multicast session while operating in the inactive mobility state.

5. The method according to claim 1, wherein when the first UE has not received the group paging message to the group of UEs receiving the session data of the multicast session implies to the first UE that the multicast session has been activated.

6. A method performed by a network node for handling a multicast session between the network node and a group of UEs comprising at least a first UE in a wireless communications network, the first UE operating under a second Discontinuous Reception, DRX, configuration, the method comprising:
transmitting to the group of UEs a group paging message indicating that the multicast session is activated; and
transmitting to the group of UEs, session data associated with the multicast session, the session data being transmitted to be at least partly receivable by the first UE operating under the second DRX configuration, and thereby further indicating to the first UE that the multicast session is activated.

7. The method according to claim 6, wherein the first UE is configured to be able to selectively operate under a first DRX configuration or the second DRX configuration, and when the first UE operates under the first DRX configuration, the first UE monitors the multicast session during a first set of Monitoring Occasions, MOs, and refrains from monitoring the session during a first cycle time, and when the first UE operates under the second DRX configuration, the first UE monitors the session during a second set of MOs, and refrains from monitoring the session during a second cycle time, wherein the second cycle time is longer than the first cycle time, and wherein the first set of MOs comprises the second set of MOs.

8. The method according to claim 7, wherein the second set of MOs is structured to comprise at least at least one part of MOs mapped to adjacent slots in a radio frame.

9. The method according to claim 6, wherein the first UE is configured to operate in an inactive mobility state.

10. The method according to claim 6, wherein transmitting the session data associated with the multicast session implies to the first UE that the multicast session has been activated.

11.-14. (canceled)

15. A first UE configured to handle a multicast session between a network node and a group of UEs comprising at least the first UE, in a wireless communications network, the first UE being configured to operate under a second Discontinuous Reception, DRX, configuration, the first UE further being configured to:
detect that the multicast session is activated by any one of: receive, a group paging message to the group of UEs indicating that the multicast session is activated, or by receive, session data of the multicast session; and
in response to detecting that the multicast session is activated, switch, from the second DRX configuration to a first DRX configuration, the first DRX configuration indicating that the first UE shall monitor all session data transmitted in the multicast session, and the second DRX configuration indicating that the first UE shall monitor a subset of all the session data transmitted in the multicast session.

16. The first UE according to claim 15, wherein the first DRX configuration comprises: monitoring the multicast session during a first set of Monitoring Occasions, MOs, and refraining from monitoring the session during a first cycle time, and wherein the second DRX configuration comprises: monitoring the session during a second set of MOs, and refraining from monitoring the session during a second cycle time, wherein the second cycle time is longer than the first cycle time, and wherein the first set of MOs comprises the second set of MOs.

17. The first UE according to claim 16, wherein the second set of MOs is structured to comprise at least at least one part of MOs mapped to adjacent slots in a radio frame.

18. The first UE according to claim 15, further configured to operate in an inactive mobility state and further configured to:
when the first UE has switched to the first DRX configuration, receive session data of the multicast session while operating in the inactive mobility state.

19. The first UE according to claim 15, wherein when the first UE has not received the group paging message to the group of UEs receiving the session data of the multicast session implies to the first UE that the multicast session has been activated.

20. A network node configured to handle a multicast session between the network node and a group of UEs comprising at least a first UE in a wireless communications network (100), the first UE operating under a second Discontinuous Reception, DRX, configuration, the network node being further configured to:
transmit to the group of UEs a group paging message indicating that the multicast session is activated; and
transmit session data associated with the multicast session, the session data being transmitted to be at least partly receivable by the first UE operating under the second DRX configuration, and thereby further indicating to the first UE that the multicast session is activated.

21.-24. (canceled)

25. The method according to claim 2, wherein the first UE is configured to operate in an inactive mobility state, and wherein the method further comprising:
when the first UE has switched to the first DRX configuration, receiving session data of the multicast session while operating in the inactive mobility state.

26. The method according to claim 2, wherein when the first UE has not received the group paging message to the group of UEs, receiving the session data of the multicast session implies to the first UE that the multicast session has been activated.

27. The method according to claim 7, wherein the first UE is configured to operate in an inactive mobility state.

28. The method according to claim 7, wherein transmitting the session data associated with the multicast session implies to the first UE that the multicast session has been activated.
